(19) United States
(12) Patent Application Publication
(10) Pub. No.: US 2006/0064879 A1
(43) Pub. Date: Mar. 30, 2006

(54) Adjustable ergonomic scissors

(76) Inventors: Pamela Sue Lauritzen, Garland, TX (US); Charles Robert Lauritzen, Garland, TX (US)

Correspondence Address: Robert M. Mason;Mason & Petruzzi, 13601 Preston Rd., 402W, Dallas, TX, 75240, US

(21) Appl. No.: 10/954,888

(22) Filed: Sep. 30, 2004

(51) Int. Cl. B26B 13/20

(52) U.S. Cl. 30/232; 30/314

(57) ABSTRACT

An adjustable ergonomic scissors has a thumb ring shank, finger ring shank and longitudinal axis along the scissor blade direction. The scissors includes a thumb ring both slidable and rotatable along the thumb ring shank. A finger ring shaft is offset approximately between 15° and 45° from the longitudinal axis of the scissor blades and a connector is positioned along the finger ring shank that allows a finger ring to be adjustably positioned in relation to the finger ring shank. When in the closed position, the thumb ring and finger ring offset form each other to ergonomically fit in a user's hand. The scissors thereby adjusts to a user's hand to improve use.

### BACKGROUND OF THE INVENTION

This invention relates generally to the field of hand operated scissors and more particularly to an adjustable ergonomic scissors.

Scissors are a cutting instrument with two blades, the edges of which slide past each other. The blades are attached by a common fulcrum in the form of a screw or a pin, and they operate simultaneously by lever action when the handles are pushed together. Different types of scissors are designed for specific uses, but they are all based on the same lever principle. In addition to their household use, specially designed scissors are used in surgery, embroidery, manicuring and by professional dressmakers and hairdressers, including pet groomers, among others.

FIG. 7 shows a view of the traditional shear or scissor design wherein the thumb of the operator is protruding too far through the thumb ring and the thumb 27 is overextended, misaligned and straining to conform to the tool. The index finger 28 is overextended, misaligned and unable to properly support the tool, while the middle finger 29 is overextended, misaligned and unable to assist the index finger in support of the tool. The ring finger 30 is overextended, and unable to stabilize the rolling movement of the shear while straining to align with the finger ring of the scissor or shear and the little finger 31 is overextended, and straining to assist the ring finger to stabilize the rolling and pitching movements of the shear blades as shown by line 32.

An example of a scissor design can be found in U.S. Pat. No. 5,109,608, which discloses a scissor with an offset thumbhole. Another example of a design can be found in U.S. Pat. No. 5,722,171, which is an ergonomic scissor with adjustable shanks that rotate outward, permitting pivoting in the plane of the handles. The two handles can be locked in various positions, but are limited to one general direction of adjustment. The '171 patent design allows adjustment only between the finger and thumbholes—an increase of space between the two, which is limited to the change of angle in one direction only.

Prior attempts at scissor design have not successfully addressed the need for a scissor to conform to the natural way in which the human hand operates os as to reduce strain and stress while operating the scissors.

### BRIEF SUMMARY OF THE INVENTION

The primary advantage of the invention is to provide an ergonomic scissor design that increases comfort, efficiency, and control by conforming to the physiological variations of the human hand, fingers, and thumb thereby reducing physiological and neuromuscular strain.

Another advantage of the invention is to provide an improved scissor that increases the ease and efficiency of operation, resulting in improved speed of use, smoothness of action, and stability of the blades.

Another advantage of the invention is to achieve better balance of the scissors or shear, thereby reducing lateral and vertical motion of the blades.

In accordance with a preferred embodiment of the present invention, an adjustable ergonomic scissors having a thumb ring shank, finger ring shank and longitudinal axis along the scissor blade direction, the scissors comprises a thumb ring both slidable and rotatable along the thumb ring shank, a finger ring shaft offset approximately between 15° and 45° from the longitudinal axis of the scissor blades, a connector along the finger ring shank that allows a finger ring to be adjustably positioned in relation to the finger ring shank, and the thumb ring and finger ring offset form each other when the scissors is in the closed position to ergonomically fit in a user's hand.

Other objects and advantages will become apparent from the following descriptions, taken in connection with the accompanying drawings, wherein, by way of illustration and example, an embodiment of the present invention is disclosed.

### BRIEF DESCRIPTION OF THE SEVERAL DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an overview of the adjustable ergonomic scissors according to a preferred embodiment of the present invention

FIG. 2 is plan view of the invention as shown in FIG. 1 showing the adjustable thumb ring according to a preferred embodiment of the present invention

FIG. 3 shows an exploded view of the adjustable thumb ring assembly according to a preferred embodiment of the present invention

FIG. 4 is a magnified view of the shank-to-finger ring connector according to a preferred embodiment of the present invention.

FIG. 5 is an exploded view of the shank-to-finger ring connector of FIG. 4.

FIG. 6 in an overhead view of a preferred embodiment of the present invention as held by the operator.

FIG. 7 is an overhead view of the traditional shear or scissor design help by an operator.

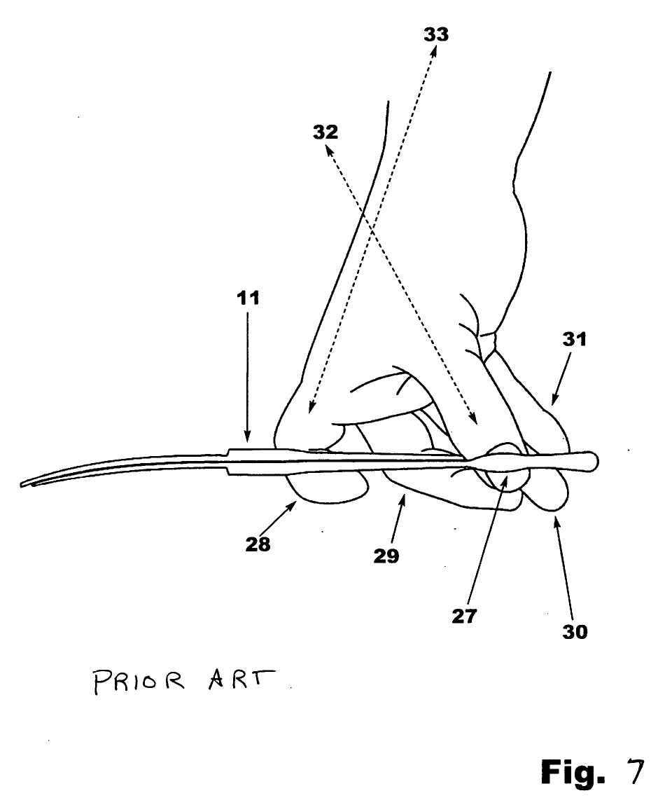

### DETAILED DESCRIPTION OF THE PREFERRED EMBODIMENTS

Detailed descriptions of the preferred embodiments are provided herein. It is to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner.

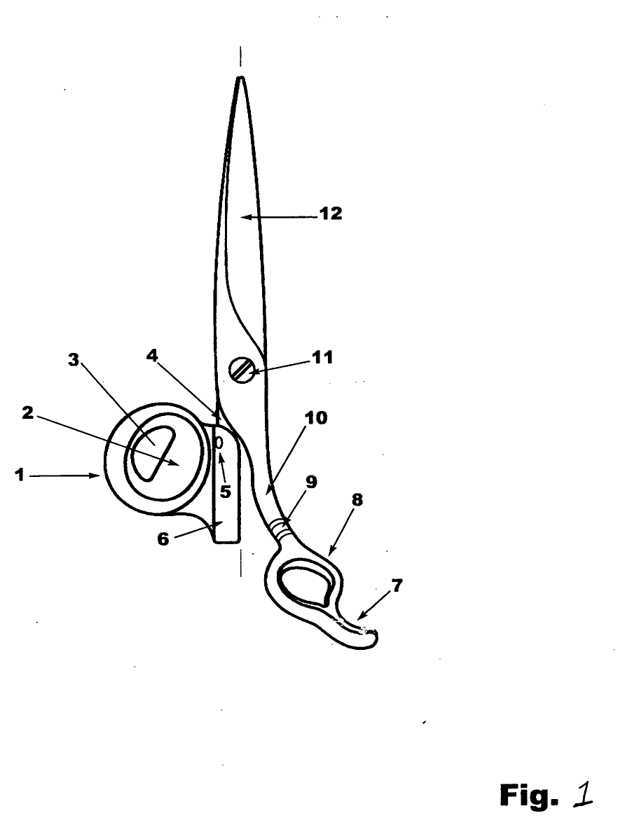

Turning first to FIG. 1, there is shown an overview of the scissor according to a preferred embodiment of the present invention depicting one visible cutting blade 12, the second cutting blade is hidden from view. The pivot screw 11 fastens the two blades of the shear or scissor together. There is illustrated shortened upper or thumb shank 4 to which the thumb ring assembly is attached, and curved lower shank 10. In the illustrated embodiment, there is also shown thumb ring assembly including the thumb ring 1, the concavely, contoured thumb pad 2 having semi-circular opening 3 within the thumb ring to limit the thumb through the thumb ring, the threaded opening for the set screw 5 that fixes the rotation of the thumb ring assembly once it has been adjusted to fit the operator's thumb, and the lower portion of the thumb ring assembly 6 that attaches the entire thumb ring assembly by sliding onto the shortened upper shank of the shear or scissor; a fully assembled view of shank-to-finger ring connector 9, finger ring 8, and tang 7. Thumb pad 2 is a tapered shelf that is deepest into the thumb ring assembly at the uppermost plane at which it meets the described semi-circular opening and gradually tapers downward to the plane at which it merges into the body nearest to its attachment to the shank of the scissor.

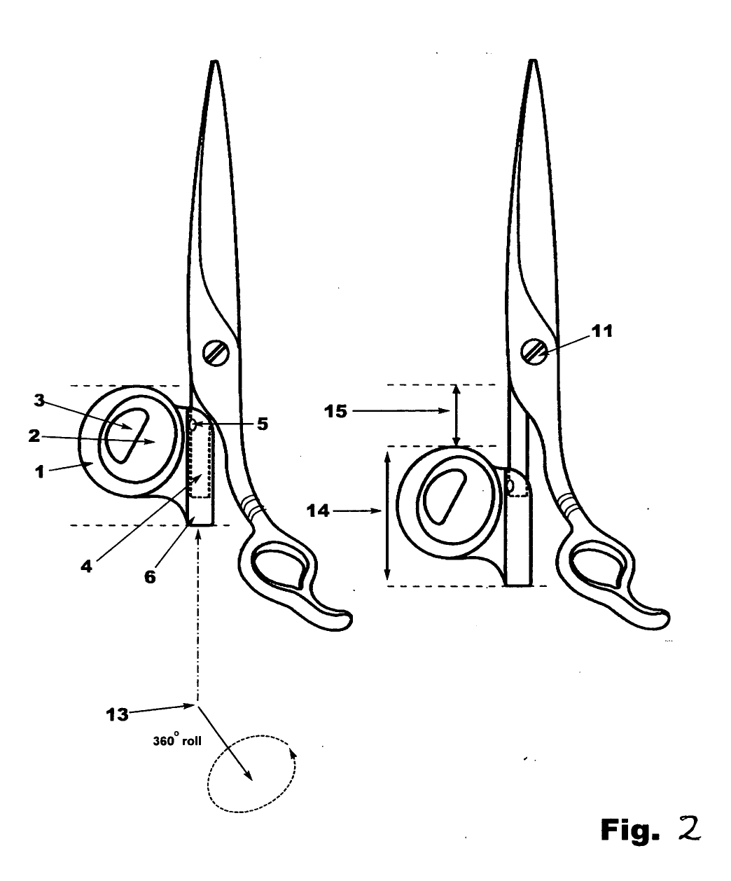

Turning to FIG. 2 there is shown a view of the adjustable thumb ring assembly according to a preferred embodiment of the present invention depicting the facets comprising the thumb ring assembly, the 360° range of roll 13 of the thumb ring assembly about shaft 4, the up to 0.75 inch sliding movement that positions the thumb ring assembly nearer to and farther from pivot screw 11, shown at 15 and 14, respectively, thumb ring 1, thumb pad 2, the semi-circular opening 3 in thumb pad 2, an enlarged view of the lower portion of thumb ring assembly 6 that slides onto shortened upper shank 4 depicting the shank within the lower portion of the thumb ring assembly, and the threaded opening 5 for the set screw. In operation, once the thumb ring assembly is positioned, the set screw is tightened, thereby adjustable setting the thumb ring.

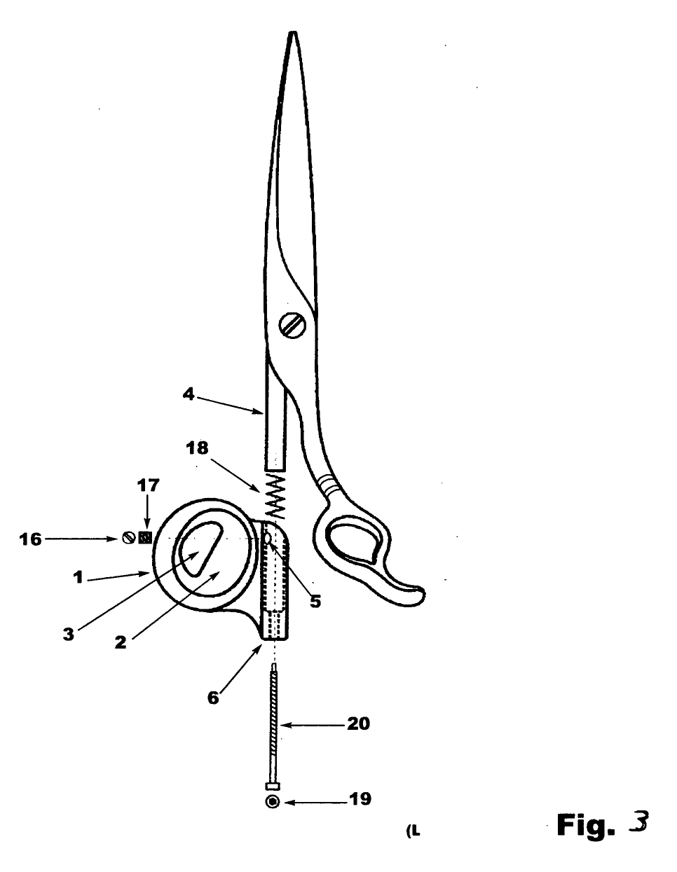

Turning to FIG. 3 there is shown an exploded view of the adjustable thumb ring assembly according to a preferred embodiment of the present invention depicting the thumb ring assembly. The lower portion of the thumb ring assembly that slides onto the shortened upper shank depicting the thumb ring assembly in a detached position 6. End view 16 and lateral view 17 of the set screw that secures and locks the rotation of the thumb ring assembly once it has been adjusted to fit the operator's thumb are shown. End view 19 and lateral view 20 view of the bolt that threads into the body of the shortened upper shank to adjust and secure the sliding motion of the thumb ring assembly are shown as well as the separation 18 of the thumb ring assembly from the shortened upper shank.

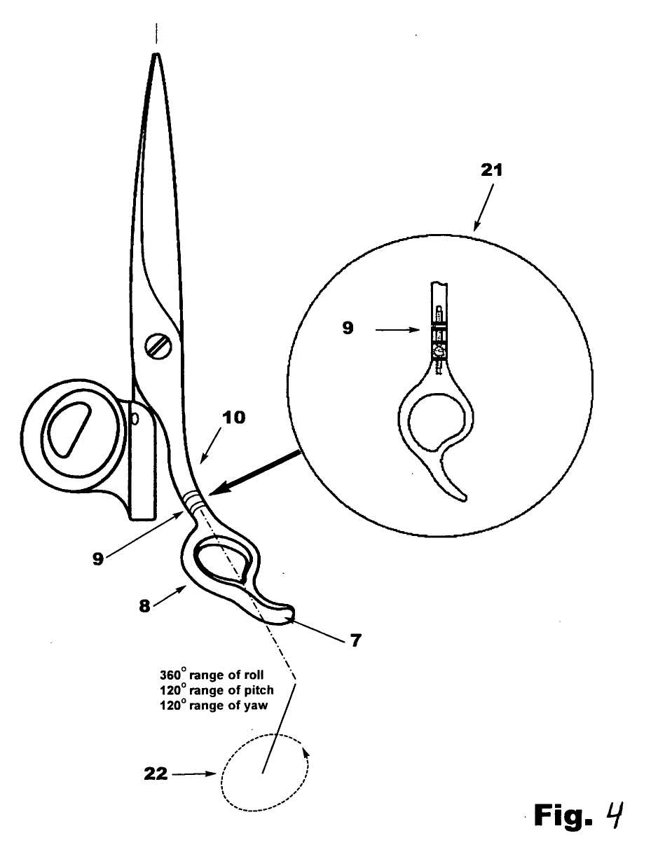

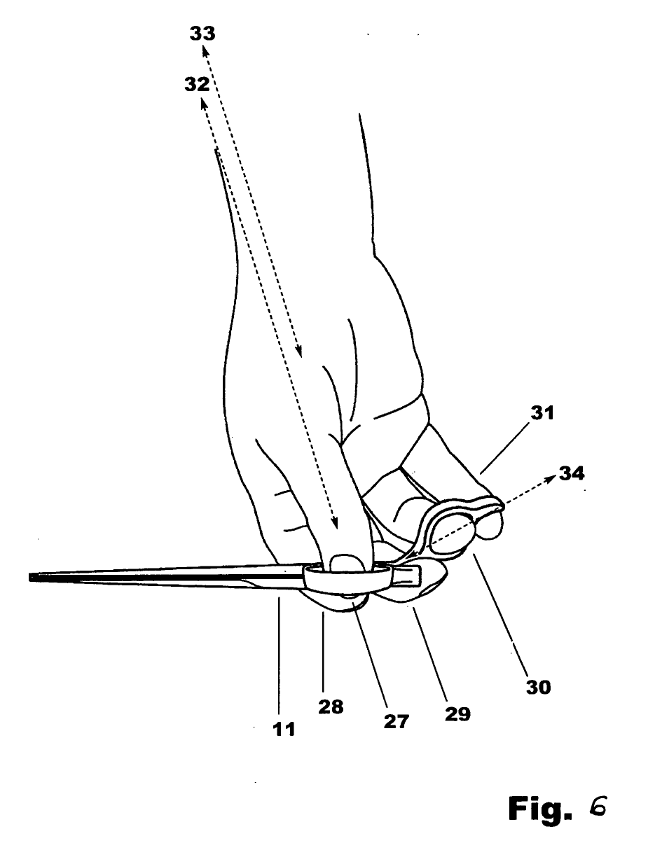

Turning to FIG. 4, there is shown a magnified view of the shank-to-finger ring connector in relationship to the approximately 15°-45° curved lower shank of the shear according to a preferred embodiment of the present invention depicting the curved lower shank 10. The curve is in relation to the longitudinal axis of the blades and is shown also in FIG. 6. Shank-to-finger ring connector 9, finger ring 8 that connects to shank-to-finger ring connector, and tang 7 that is an appendage of the finger ring are also shown. A magnified view of the shank-to-finger ring connector in a fully assembled configuration is shown at 21, and a fully assembled configuration of the shank-to-finger ring connector illustrating the 360° roll, 120° pitch, and 120° yaw capabilities of the shank-to-finger ring connector is depicted at 22.

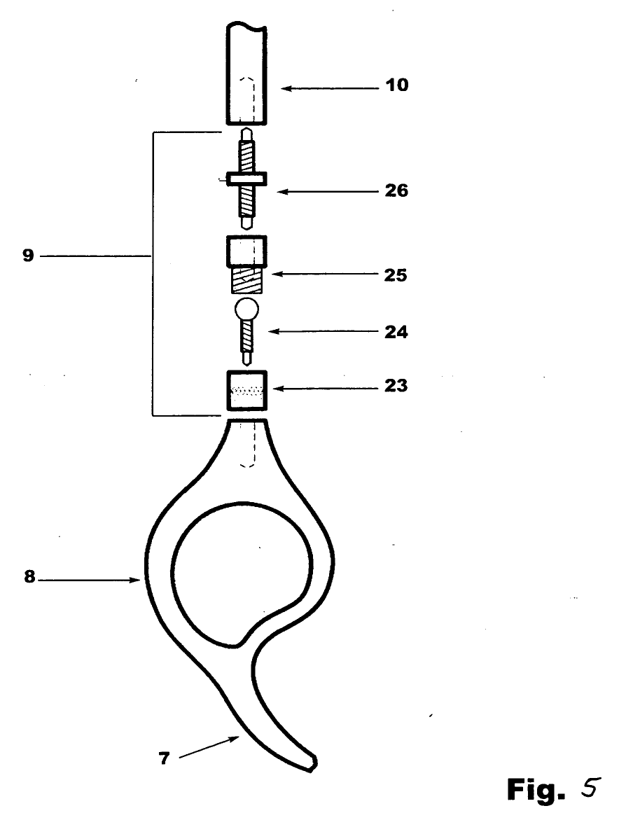

Turning to FIG. 5, there is shown an exploded view of the shank-to-finger ring connector 9 according to a preferred embodiment of the present invention in relation to the distal end of the curved lower shank 10. The dual threaded assembly 26 has opposing left-hand and right-hand threads that draws the distal end of the curved shank into the proximal end of the upper portion of the ball and stem socket assembly item 25. Dual threaded, upper proximal ball and stem socket assembly 25, which may have a concave inner surface, seats and encloses the ball and stem while internally coupling to the distal lower threaded portion of the ball and stem socket assembly 23, which may also have a concave inner surface. Ball and threaded stem assembly 24 passes through the lower portion of the ball socket assembly 23 and couples into the proximal end of the finger ring 8. Ball and socket assembly 24, into which the ball and threaded will be adjustably set when the assembly is tightened

FIG. 6: An overhead view of the scissors according to a preferred embodiment of the present invention as held by the operator, depicting a thumb nestled into shear thumb pad 27, index finger 28 at the closest possible proximity to the pivot screw while supporting the shear, middle finger 29 providing support to the index finger as well as support of the shear, ring finger 30 in the finger ring stabilizing the scissors, and little finger 31 providing support to the ring finger. Longitudinal axis 32 of the thumb in the relaxed posture is in alignment with the longitudinal axis of the operator's arm 33 and the approximate position of the pivot screw 11.

It will be appreciated that any one portion of the described scissors may be employed without the necessity to employ any one or more of the other features in a particular scissor embodiment.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An adjustable ergonomic scissors having a thumb ring shank, finger ring shank and longitudinal axis along the scissor blade direction, the scissors comprising:
a thumb ring both slidable and rotatable along the thumb ring shank;
a finger ring shaft offset approximately between 15° and 45° from the longitudinal axis of the scissor blades;
a connector along the finger ring shank that allows a finger ring to be adjustably positioned in relation to the finger ring shank; and
the thumb ring and finger ring offset form each other when the scissors is in the closed position to ergonomically fit in a user's hand:
